(19) United States
(12) Patent Application Publication
(10) Pub. No.: US 2026/0326321 A1
(43) Pub. Date: Oct. 22, 2026

(54) BLADE GUIDE SYSTEM AND ELECTRIC HAIR CUTTING DEVICE INCORPORATING SAME

(71) Applicant: WAHL CLIPPER CORPORATION, Sterling, IL (US)

(72) Inventors: James Harry CHAMBERS, Woodruff, WI (US); Steven Wayne ARNDT, Geneseo, IL (US)

(21) Appl. No.: 19/376,216

(22) Filed: Oct. 31, 2025

Related U.S. Application Data
(60) Provisional application No. 63/792,513, filed on Apr. 22, 2025.

(51) Int. Cl. B26B 19/06; B26B 19/28; B26B 19/38

(52) U.S. Cl. CPC B26B 19/06; B26B 19/28; B26B 19/386

(57) ABSTRACT

A blade guide system and electric hair cutting device incorporating same includes a stationary blade and a moving blade movable in first and second directions along a cutting axis defined by the bladeset. The bladeset also includes a cam follower mounted to the moving blade. The cam follower includes at least one guide slot. A blade guide bracket is mounted to the stationary blade. The blade guide bracket includes at least one guide arm. The guide arm includes a downwardly depending guide portion respectively received in the guide slot of the cam follower.

### RELATED APPLICATION

The present application claims the benefit under 35 USC 119(e) of US Provisional Application No. 63/792,513 filed Apr. 22, 2025, the entire contents of which are incorporated by reference herein.

### BACKGROUND

The present invention relates generally to electric hair cutting devices such as hair clippers and hair trimmers, and more specifically to mechanical guiding systems for guiding a reciprocating motion of a moving blade relative to a stationary blade of an electric hair cutting device.

Electric hair cutting devices include a moving blade that laterally reciprocates in relation to a stationary blade to perform a cutting action. Both the moving blade and the stationary blade have teeth, and both blades are collectively referred to as the bladeset. Hair caught between the teeth of the blades is sheared through movement of the moving blade relative to the stationary blade.

Contemporary electric hair cutting devices also include an electric motor that is powered by an on-board battery, and/or via a supply voltage from an outlet. The motor is mechanically coupled to the moving blade to produce the reciprocation of the moving blade via one of a variety of different mechanical linkage formats (e.g. eccentric cam arrangements, pivot arm arrangements, etc.).

To ensure a linear motion of the moving blade relative to a stationary blade, electric hair cutting devices may include a blade guide system. One example of a conventional blade guide system incorporates a blade guide that is typically embodied as a sliding block-like component rigidly connected to an underside of the moving blade. The blade guide nests within a channel formed in an upper surface of the stationary blade. Due to the close sizing of the width of the blade guide relative to the width of the channel, the blade guide may only move primarily along a longitudinal axis defined by the length of the channel. With such a configuration, the blade guide is effectively positioned between the moving blade and the stationary blade. Due to this rigid connection, the moving blade’s reciprocating motion is confined to a generally linear motion to ensure optimized hair cutting operation.

However, positioning the blade guide between the moving blade and the stationary blade has some drawbacks. First, due to the sliding contact of the blade guide within the channel of the stationary blade, the blade guide tends to wear over time. This wear can lead to a deviation from the desired linear movement of the moving blade relative to the stationary blade. Second, because the blade guide is a separate component fixedly attached to the moving blade, the total mass which the motor must move to perform the hair cutting operation is increased, thereby effecting motor design, battery life, etc.

Attempts have been made to address the above. For example, United States Patent No. 9,144,911 to Arndt et al., (hereinafter the ‘911 Patent) the disclosure of which is hereby incorporated by reference in its entirety, discloses a blade guide system that effectively positions the blade guide above the moving blade. In the ‘911 Patent, a linear guide rail is formed on a cam follower. The cam follower is positioned over a top surface of the moving blade and attached to the moving blade. The guide rail is received within a linear guide channel attached to a housing of the electric hair cutting device described therein.

In the design of the ‘911 Patent, as the cam follower moves under operation of an eccentric cam, so too does the moving blade. However, because the guide rail is constrained within the guide channel, the reciprocating motion of the moving blade is linear. This configuration has the advantage of reduced wear on the blade guide system given that it is not in direct sliding contact with the stationary blade.

Also in the design of the ‘911 Patent, the use of the guide rail directly on the cam follower does not add an appreciable amount of mass to the moving blade unlike the aforementioned blade guide systems that utilize an additional block-like component positioned between the moving blade and the stationary blade. While this guide rail/guide channel configuration described in the ‘911 Patent is very effective, the cam follower does experience some moment force loading due to the spacing from where the force of the eccentric cam is applied to the cam follower and where the guide rail formed on the cam follower mates with the guide channel. Additionally, because the guide channel is separately configured on the housing, its location must be tightly controlled to ensure adequate mating with the guide rail to maintain linear guiding.

Accordingly, there is a need for an improved blade guide system that provides the advantages of an over-the-blade guide system, but with reduced moment force loading on the cam follower during operation and other operational improvements.

### SUMMARY

In one aspect, an electric hair cutting device is provided. An embodiment according to this aspect includes a housing having a first end and a second end opposite the first end. A bladeset is mounted to the housing at the first end. A motor is situated within the housing and operably connected to the bladeset to produce a hair cutting action by the bladeset. An embodiment of the bladeset according to this aspect includes a stationary blade and a moving blade movable in first and second directions along a cutting axis defined by the bladeset. The bladeset also includes a cam follower mounted to a top surface the moving blade and a blade guide bracket mounted to the stationary blade. A portion of the blade guide bracket extending over the top surface of the moving blade and is in sliding engagement with the cam follower.

In an embodiment according to this aspect, the bladeset is removable from the hair clipper housing as a sub-assembly. The bladeset mounts to the first end of the housing via a snap-fit connection. The blade guide bracket includes at least one mounting projection for mounting the bladeset to the housing via the snap-fit connection. The at least one mounting projection is arranged to receive a portion of at least one retainer. In a particular embodiment, the at least one retainer is mounted to the housing and is a spring clip.

In an embodiment according to this aspect, the portion of the blade guide bracket extending over the top surface of the moving blade includes at least one guide arm. The at least one guide arm has a cantilever extension over the top surface of the moving blade. The at least one guide arm also includes a downwardly depending guide portion. The cam follower includes at least one guide slot. The guide portion of the at least one guide arm is received within the least one guide slot, respectively. In a particular embodiment, the at least one guide arm includes a pair of guide arms, and the at least one guide slot includes a pair of guide slots.

In another aspect, a bladeset for an electric hair cutting device is provided. An embodiment of a bladeset according to this aspect includes a stationary blade and a moving blade movable in first and second directions along a cutting axis defined by the bladeset. The bladeset also includes a cam follower mounted to the moving blade. The cam follower includes at least one guide slot. A blade guide bracket is mounted to the stationary blade. The blade guide bracket includes at least one guide arm. The at least one guide arm includes a downwardly depending guide portion respectively received in the at least one guide slot of the cam follower.

In an embodiment according to this aspect, the blade guide bracket includes a base portion mounted to the stationary blade. The at least one guide arm extends from the base portion. The base portion of the blade guide bracket includes a spring retainer. A blade tension spring is mounted to the spring retainer of the blade guide bracket.

In an embodiment according to this aspect, the at least one guide arm includes a mounting projection. The mounting projection is configured for snap-fit connection to a housing on an electric hair cutting device.

In an embodiment according to this aspect, the at least one guide slot opens to a lateral side of the cam follower. The at least one guide arm includes a pair of guide arms The at least one guide slot includes a pair of guide slots such that a sliding contact is formed between the pair of guide arms and the pair of guide slots, and each guide slot includes a notch.

In an embodiment according to this aspect, the cam follower includes a cam receiving structure including a slot for receipt of an eccentric cam. Clearance slots are formed through the cam follower proximal to opposing sides of the cam receiving structure. The clearance slots are arranged to allow lateral deflection of the cam receiving structure.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is perspective exploded view of an embodiment of an electric hair cutting device constructed in accordance with the teachings herein;

FIG. 2 is a perspective view of a bladeset of the electric hair cutting device of FIG. 1;

FIG. 3 is a perspective view of a blade guide bracket of the bladeset of FIG. 2;

FIG. 4 is a perspective view of a cam follower of the bladeset of FIG. 2;

FIG. 5 is a plan view of the blade guide bracket and cam follower in an operational position;

FIG. 6 is a plan view of the blade guide bracket and cam follower in another operational position;

FIG. 6A is a plan view of an alternate embodiment of the blade guide bracket of FIG. 6;

FIG. 7 is a partial perspective view of the electric hair cutting device of FIG. 1, with an upper housing thereof removed; and

FIG. 8 is a perspective cross section of the electric hair cutting device of FIG. 1.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION

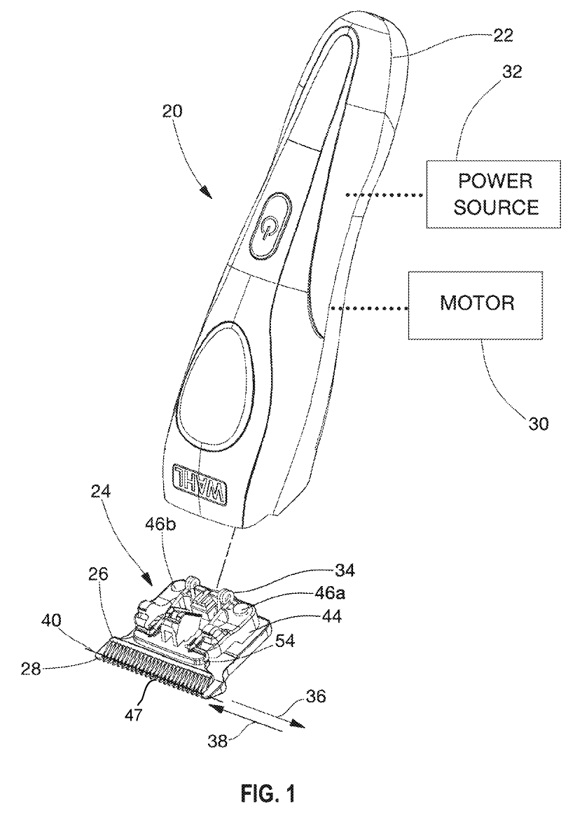

Turning now to the drawings, FIG. 1 illustrates an exemplary embodiment of an electric hair cutting device embodied herein for non-limiting example as a hair clipper 20. Hair clipper 20 includes a housing 22 having a first end and a second end. A bladeset 24 is mounted at the first end. Bladeset 24 includes a moving blade 26 which moves relative to a stationary blade 28 to produce a hair cutting action. While the following description will be provided in the context of a hair clipper of the type shown in FIG. 1, the invention is not limited to the device illustrated, and it is envisioned that the teachings herein may be readily applied to other devices such as hair trimmers, or any other electric hair cutting device having a reciprocating blade.

Hair clipper 20 includes an internal electric motor 30 powered via a power source 32. It will be recognized from the description herein that the invention is not constrained to a particular power source or a particular motor type. For example, power source 32 may be embodied by an internal battery carried by housing 22 or may be an external power source such as a supply voltage provided by a wall outlet.

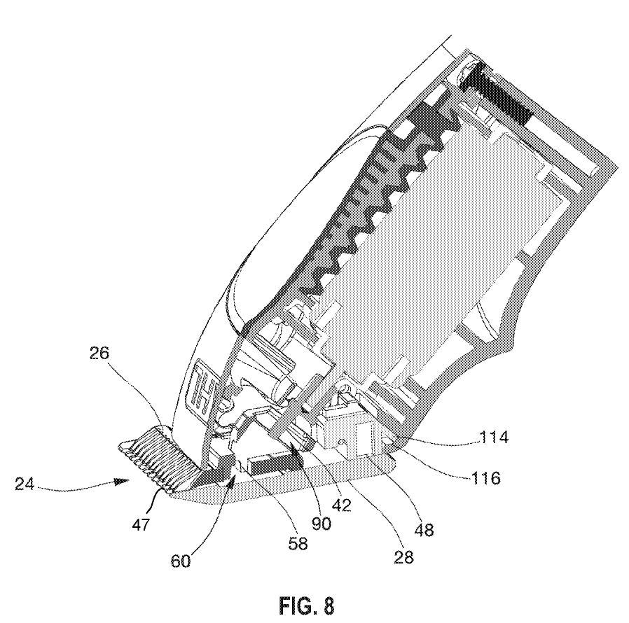

A mechanical linkage connects motor 30 to bladeset 24 to induce a reciprocating motion to moving blade 26 relative to stationary blade 28 to provide a cutting action. For non-limiting example, the mechanical linkage may be embodied as an eccentric cam 42 (see FIG. 8) connected to an output shaft of the motor.

More specifically, moving blade 26 is operable to reciprocate in first and second cutting directions 36, 38 along a cutting axis 40. Cutting axis 40 is defined generally at the line defined by the tips of a plurality of moving teeth 46 of moving blade 26 as located relative to a plurality of stationary teeth 47 of stationary blade 28. While not shown, hair clipper 20 may also include an adjustment mechanism, for example a device referred to in the art as a taper lever, for adjusting a relative distance between the tips of the teeth of moving blade 26 and the tips of the teeth of stationary blade 28.

A tension spring 34 is also provided, which applies a generally downward force against moving blade 26 to maintain a firm contact with stationary blade 28 to ensure optimal cutting. Additionally and explained in greater detail below, bladeset 24 is removable as a sub-assembly, i.e. as a single intact and assembled unit, from housing 22. This advantageously allows the user to interchange different bladesets having, for example, different blade geometries depending upon application. Such a configuration also advantageously allows for quick cleaning of bladeset 24 and an interior of housing 22 as needed.

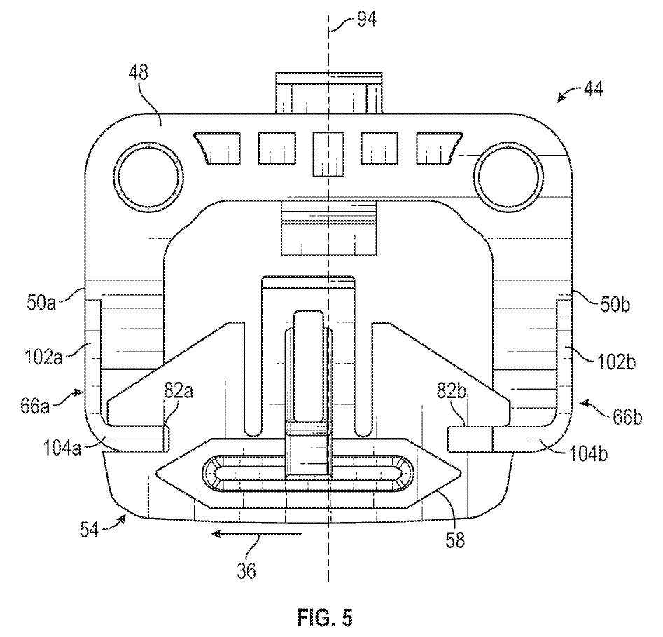

Bladeset 24 includes a blade guide bracket 44 mounted to stationary blade 26 using mechanical fasteners 46a, 46b as shown. A cam follower 54 is fixedly connected to stationary blade 26, and as a result, any linear reciprocating motion of cam follower 54 produces a like linear reciprocating motion of moving blade 26 when cam follower 54 is acted upon by eccentric cam 42 (see FIG. 8). Cam follower 54 may be fixedly connected to moving blade 26 via any mechanical expedient. In the illustrated embodiment, cam follower 54 includes a keyed projection 58 (see FIG. 5) that is received within a keyed opening 60 (see FIG. 8) of moving blade 26.

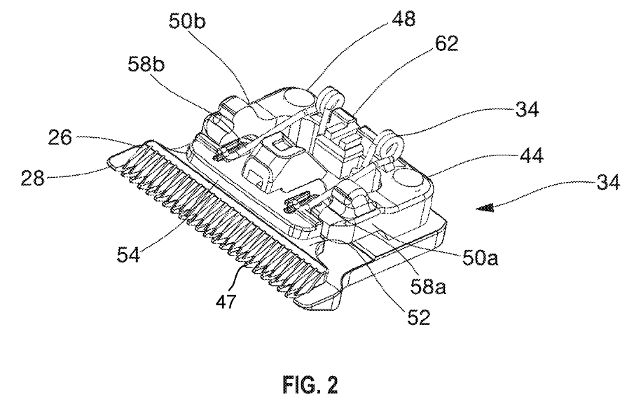

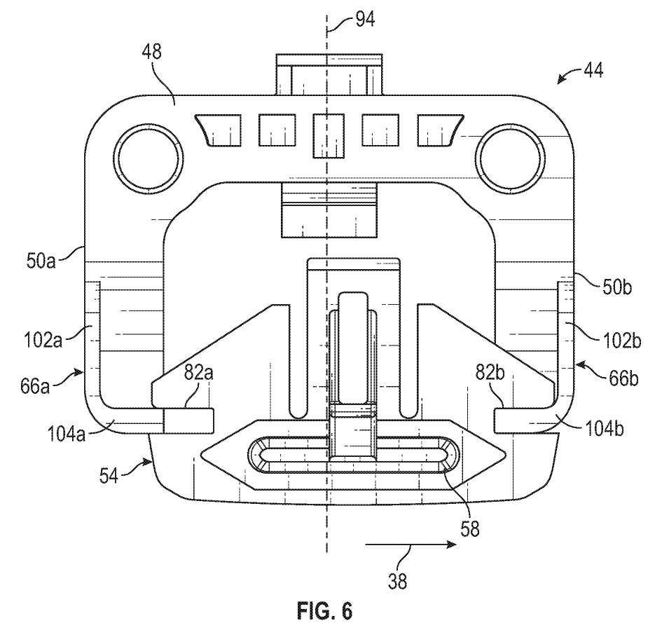

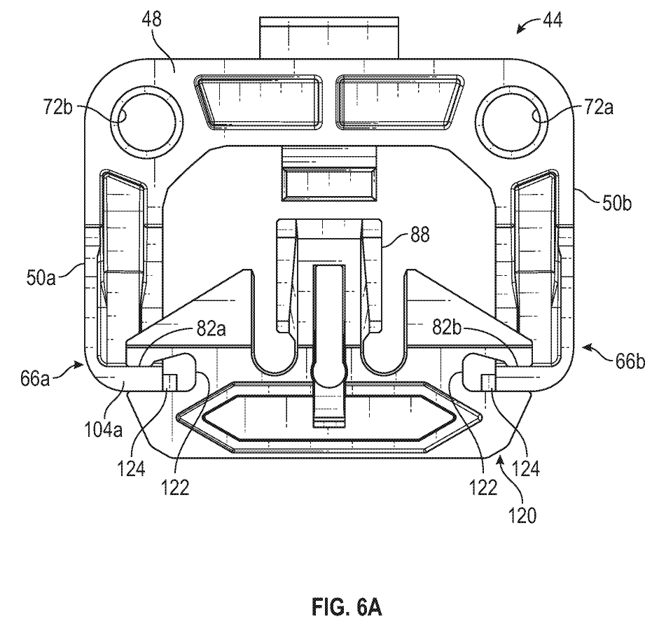

Turning now to FIG. 2, blade guide bracket 44 includes a base portion 48 and at least one guide arm extending therefrom. In the illustrated embodiment, a pair of identical guide arms 50a, 50b extend from base portion 48. As will be understood from the following, a single guide arm could be utilized in other embodiments, or alternatively, more than two guide arms could also be employed. Guide arms 50a, 50b extend over a top surface 52 of moving blade 26 and form a slidable connection with the cam follower 54 of bladeset 24. As explained relative to FIGS. 5 and 6, this slidable connection ensures a linear reciprocating movement of cam follower 54. A spring retainer 62 is formed on base portion 48. Spring retainer 62 retains tension spring 34 such that spring arms 58a, 58b of tension spring apply the above referenced downward force onto moving blade 26 indirectly through cam follower 54.

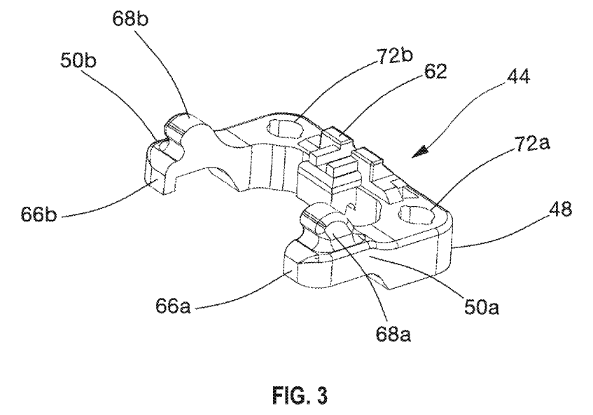

With reference to FIG. 3, each guide arm 50a, 50b includes a guide portion for forming the aforementioned slidable connection with cam follower 54 (see FIG. 2). In the illustrated embodiment, the guide portion of each guide arm 50a, 50b is formed via a downwardly depending skirt 66a, 66b thereon. It is contemplated, however, that any structural feature may be included on guide arms 50a, 50b for forming a slidable connection with cam follower 54. For example, the guide portion of each guide arm 50a, 50b could be embodied as a downwardly depending tab. Further, each guide arm 50a, 50b could instead incorporate a slot for receiving a corresponding tab or similar structure depending upwardly from cam follower 54.

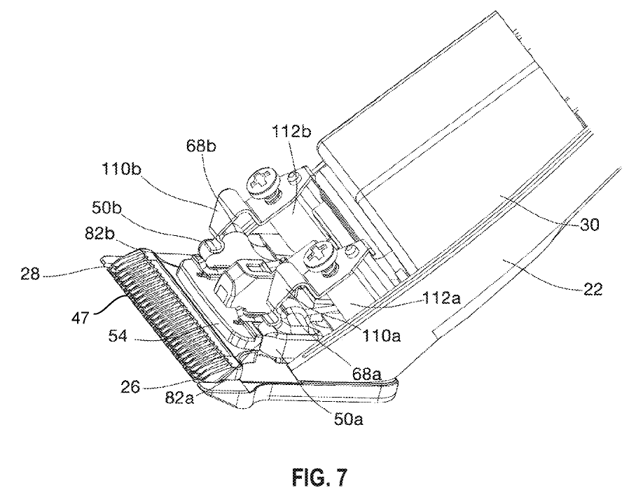

Each guide arm 50a, 50b also includes a mounting projection 68a, 68b extending in a direction generally opposite to skirts 66a, 66b. As explained below relative to FIGS. 7 and 8, mounting projections 68a, 68b are utilized for forming a snap-fit connection of bladeset 24 to housing 22 (see also FIG. 1). As used herein, “snap-fit connection” means a fixed connection achieved by hand without the use of tools. Additionally, mounting holes 72a, 72b are formed through base portion 48 for receiving fasteners 46a, 46b (see FIG. 2). In the case of threaded fasteners 46a, 46b, mounting holes 72a, 72b may include internal threading.

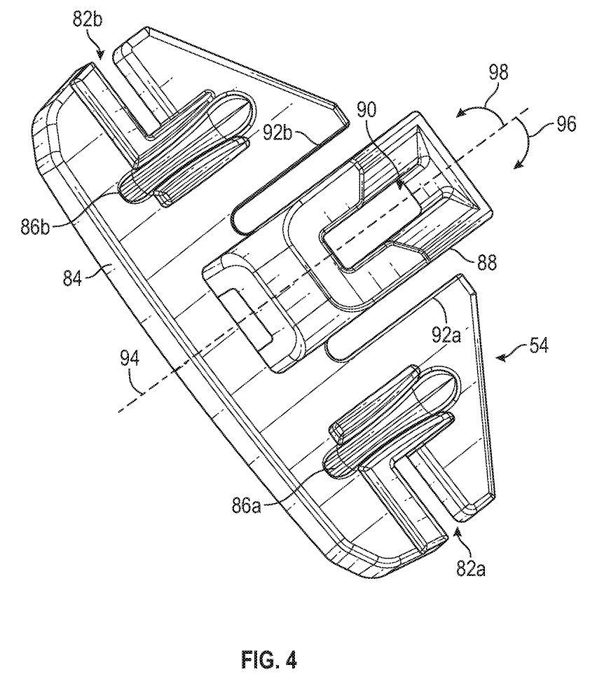

With reference to FIG. 4, cam follower 54 includes a pair of open-sided slots 82a, 82b for receiving skirts 66a, 66b (see FIG. 3). Slots 82a, 82b are formed in a base portion 84 of cam follower 54. A spring arm retaining groove 86a, 86b is formed adjacent to each slot 82a, 82b a shown. Retaining rooves 86a, 86b provide seats for each spring arm 58a, 58b as is shown in FIG. 2. A cam receiving structure 88 extends upwardly from based portion 84 and includes a cam slot 90 for receipt of eccentric cam 42 described above and as is shown in FIG. 8. Clearance slots 92a, 92b are formed through base portion 84 of cam follower 54. Clearance slots allow for minor deflection of cam receiving structure 88 relative to a central axis 94 defined by cam follower 54 as is shown by directions 96, 98. This deflection aids in overall noise reduction during the reciprocating motion of cam follower 54 during operation by serving as a mechanical shock absorber.

Turning now to FIGS. 5 and 6, the above introduced slidable connection between blade guide bracket 44 and cam follower 54 will be described in greater detail. With particular reference to FIG. 5, cam follower 54 is shown at its extremity of motion relative to blade guide bracket 44 in cutting direction 36 (see FIG. 1). Each skirt 66a, 66b is slidably received within slots 82a, 82b. Sidewall portions 102a, 102b of each skirt 66a, 66b limit the maximum amount travel of cam follower 54 in cutting directions 36, 38.

Eccentric cam 42 (see FIG. 8) may be sized such that the travel of cam follower 54 in cutting directions 36, 38 is such that cam follower will not contact sidewall portions 102a, 102b in order to reduce noise and wear. Guide portions 104a, 104bof skirts 66a, 66bare sized such that they will remain within slots 82a, 82b during the full extent of travel of cam follower 54 during operation.

A similar configuration is shown in FIG. 6, with cam follower 54 shown at its extremity of travel in cutting direction 38. Advantageously, the slidable contact between guide portions 104a, 104b and slots 82a, 82b is in close proximity to a contact point 106 of eccentric cam 42 (see FIG. 8) and cam receiving structure 88 along central axis 94 of cam follower 54. This reduces the moment forces exerted upon cam follower 54 by reducing the distance from where eccentric cam 42 exerts a force onto cam follower 54, and where guide portions 104a, 104b contact slots 82a, 82b. Such a configuration reduces wear on cam follower 54 and assists in maintaining a linear motion overall of cam follower 54 relative to blade guide bracket 44.

Turning now to FIGS. 7 and 8, the snap fit connection of bladeset 24 to housing 22 will be described in greater detail. A pair of retainers in the form of spring clips 110a, 110b are mounted to corresponding bosses 112a, 112b of housing 22. Each spring clip 110a, 110b snaps over a corresponding mounting projection 68a, 68b as shown.

With reference to FIG. 8, a tab 114 is formed on base portion 48 and nests against a seat 116 of housing 22 as shown. Spring clips 112a, 112b (see FIG. 7) exert a force against blade guide bracket 44 such that tab 114 is biased against seat 116 to firmly hold bladeset 24 against housing 22. To remove bladeset 24, a user may rotate bladeset 24 away from housing such that the force exerted by spring clips 112a, 112b is overcome, and tab 114 may be unseated from seat 116.

Referring now to FIG. 6A, and alternate to the cam follower 54 is generally designated 120. Components shared between the cam followers 54 and 120 are designated with the identical reference numbers. A main distinctive feature of the cam follower 120 is at least one and preferably a pair of notches 122 formed at inward ends 124 of the slots 82a, 82b. As such, the notches 122 are in fluid communication with the slots 82a, 82b. The notches 122 widen as the notches become closer to the cam receiving structure 88, forming a generally triangular shape. The notches 122 have been found to enhance linear guiding for relatively smaller blade offsets, mainly trimmer blades. In addition, the notches 122 reduce operational noise of the hair clipper 20 by reducing noise generated by clearance fits between engaging components. Further, the notches 122 enhance the ability to flex and have a reduced impact on blade load. Also, the notches 122 create a balance of stiffness and rigidity between the cam follower 120 and the blade guide bracket 44.

All references, including publications, patent applications, and patents cited herein are hereby incorporated by reference to the same extent as if each reference were individually and specifically indicated to be incorporated by reference and were set forth in its entirety herein.

The term “electric hair cutting device” as used herein includes any electric hair cutting device that includes a motor which drives a moving blade to cut hair, including but not limited to hair clippers, hair trimmers, and electric shavers, for human or for animal application. Further, the terms “hair clipper” and “hair trimmer” are used interchangeably unless otherwise noted by context, and do not limit the scope or applicability of the invention herein to either particular variant.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising”, “having”, “including”, and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Embodiments of this invention are described herein, including the best mode known to the inventors for carrying out the invention. Variations of those embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. An electric hair cutting device, comprising:
a housing having a first end and a second end opposite the first end;
a bladeset mounted to the housing at the first end;
a motor situated within the housing and operably connected to the bladeset to produce a hair cutting action by the bladeset;
the bladeset comprising:
a stationary blade;
a moving blade movable in first and second directions along a cutting axis defined by the bladeset;
a cam follower mounted to a top surface the moving blade;
a blade guide bracket mounted to the stationary blade, a portion of the blade guide bracket extending over the top surface of the moving blade and in sliding engagement with the cam follower.

2. The electric hair cutting device of claim 1, wherein the bladeset is removable from the hair clipper housing as a sub-assembly.

3. The electric hair cutting device of claim 2 wherein the bladeset mounts to the first end of the housing via a snap-fit connection.

4. The electric hair cutting device of claim 3, wherein the blade guide bracket includes at least one mounting projection for mounting the bladeset to the housing via the snap-fit connection.

5. The electric hair cutting device of claim 4, wherein the at least one mounting projection is arranged to receive a portion of at least one retainer, respectively, wherein the at least one retainer is mounted to the housing.

6. The electric hair cutting device of claim 5, wherein the at least one retainer is a spring clip.

7. The electric hair cutting device of claim 1, wherein the portion of the blade guide bracket extending over the top surface of the moving blade includes at least one guide arm, the at least one guide arm having a cantilever extension over the top surface of the moving blade.

8. The electric hair cutting device of claim 7, wherein the at least one guide arm includes a downwardly depending guide portion, and wherein the cam follower includes at least one guide slot.

9. The electric hair cutting device of claim 8, wherein the guide portion of the at least one guide arm is received within the least one guide slot, respectively.

10. The electric hair cutting device of claim 9, wherein the at least one guide arm includes a pair of guide arms, and wherein the at least one guide slot includes a pair of guide slots, and wherein each of the pair of guide slots includes a notch.

11. A bladeset for an electric hair cutting device, the bladeset comprising:
a stationary blade;
a moving blade movable in first and second directions along a cutting axis defined by the bladeset;
a cam follower mounted to the moving blade, the cam follower including at least one guide slot;
a blade guide bracket mounted to the stationary blade, the blade guide bracket including at least one guide arm, the at least one guide arm including a downwardly depending guide portion respectively received in the at least one guide slot of the cam follower.

12. The bladeset of claim 11, wherein the blade guide bracket includes a base portion, the base portion mounted to the stationary blade, the at least one guide arm extending from the base portion.

13. The bladeset of claim 12, wherein the base portion of the blade guide bracket includes a spring retainer.

14. The bladeset of claim 13, further comprising a blade tension spring, the blade tension spring mounted to the spring retainer of the blade guide bracket.

15. The bladeset of claim 13, wherein the at least one guide arm includes a mounting projection.

16. The bladeset of claim 15, wherein the mounting projection is configured for snap-fit connection to a housing on an electric hair cutting device.

17. The bladeset of claim 11, wherein the at least one guide slot opens to a lateral side of the cam follower.

18. The bladeset of claim 11, wherein the at least one guide arm includes a pair of guide arms, and wherein the at least one guide slot includes a pair of guide slots such that a sliding contact is formed between the pair of guide arms and the pair of guide slots.

19. The bladeset of claim 18, wherein the cam follower includes a cam receiving structure, the cam receiving structure including a slot for receipt of an eccentric cam.

20. The bladeset of claim 19, wherein clearance slots are formed through the cam follower proximal to opposing sides of the cam receiving structure, the clearance slots arranged to allow lateral deflection of the cam receiving structure.
